(19) United States
(12) Patent Application Publication
(10) Pub. No.: US 2015/0337755 A1
(43) Pub. Date: Nov. 26, 2015

(54) Piston

(71) Applicant: PERKINS ENGINES COMPANY LIMITED, Peterborough, Cambridgeshire (GB)

(72) Inventor: Vivian Page, Bourne, Lincolnshire (GB)

(73) Assignee: Perkins Engines Company Limited, Peterborough, Cambridgeshire (GB)

(21) Appl. No.: 14/758,912

(22) PCT Filed: Jan. 7, 2014
(86) PCT No.: PCT/EP2014/050150

§ 371 Date: Jul. 1, 2015

(30) Foreign Application Priority Data
Jan. 8, 2013 (EP) 13150525.7

(51) Int. Cl. F02F 3/00

(52) U.S. Cl. CPC F02F 3/0015

(57) ABSTRACT

A piston combustion bowl for a diesel engine is described. The piston may decrease the production of particulate matter during combustion of the fuel vapour in the combustion chamber. The piston may include a body having a crown about a central axis; a combustion chamber transversely disposed in the body and recessed from the crown; a centre pip disposed in the combustion chamber about the central axis; a bowl extending from the centre pip to a lip inclined relative to the crown at an angle; and a wall connected between the lip and the crown for limiting angular distribution of fuel vapour exiting the combustion chamber.

### TECHNICAL FIELD

This disclosure relates generally to pistons for internal combustion engines, and particularly to pistons for diesel engines. More particularly, the disclosure relates to a combustion bowl defined in a crown of a piston.

### BACKGROUND

Combustion of fuel in the combustion chambers of engine pistons may produce particulate matter, such as soot, and NOx emissions. There are on-going concerns for production of sufficient engine power while minimising the NOx emissions in exhaust gases and minimising the amount of particulate matter retained in the combustion chamber and released through exhaust gases. Exhaust gas after-treatment devices including catalyst and particulate filters have been generally adopted to reduce NOx and particulate matter emissions in exhaust gases.

Particulate matter and NOx emissions may be dependent on factors relating to engine design and operation. These factors may include engine compression ratio, combustion chamber structure and fuel injection spray pattern. These factors may be exploited to reduce further the level of NOx and particulate matter emissions.

The effect of the distribution and flow of the air and fuel mixture on particulate matter and NOx emissions may be determined by the structure of the combustion chamber.

US2007199538 discloses a combustion chamber for a direct-injection diesel engine, wherein mixture of air and fuel may be optimally promoted by the combustion chamber thereby effecting a balance between particulate matter reduction and NOx reduction. The combustion chamber may be formed at a top of a piston and may be symmetrical about a centre axis. The combustion chamber may have its end that is formed into a substantially polygonal shape in combination with round portions and straight portions. The reduction in particulate matter and NOx may be achieved by improving a retardation limit with respect to fuel injection timing and speeding up combustion at a high exhaust gas recirculation.

The present disclosure is directed, at least in part, to improving or overcoming one or more aspects of the prior art system.

### BRIEF SUMMARY OF THE INVENTION

The present disclosure describes a piston for a diesel engine, the piston comprising: a body having a crown about a central axis; a combustion chamber transversely disposed in the body and recessed from the crown; a centre pip disposed in the combustion chamber about the central axis; a lip inclined relative to the crown at an angle; a bowl extending from the centre pip to the lip; and a wall connected between the lip and the crown for limiting angular distribution of fuel vapour exiting the combustion chamber.

### BRIEF DESCRIPTION OF THE DRAWINGS

The foregoing and other features and advantages of the present disclosure will be more fully understood from the following description of various embodiments, when read together with the accompanying drawings, in which:

FIG. 1 is a sectional view of a piston according to the present disclosure;

FIG. 2 is a sectional view of a combustion chamber disposed in the piston of FIG. 1;

FIG. 3a is a partial sectional view of the combustion chamber of FIG. 2;

FIG. 3b is a close up sectional view of a part of the combustion chamber of FIG. 3a.

FIG. 4 is a plan view of the combustion chamber of FIG. 2; and

FIG. 5 is a close up sectional view of a part of the combustion chamber with indication of the path of the fuel vapour and combustion products.

### DETAILED DESCRIPTION

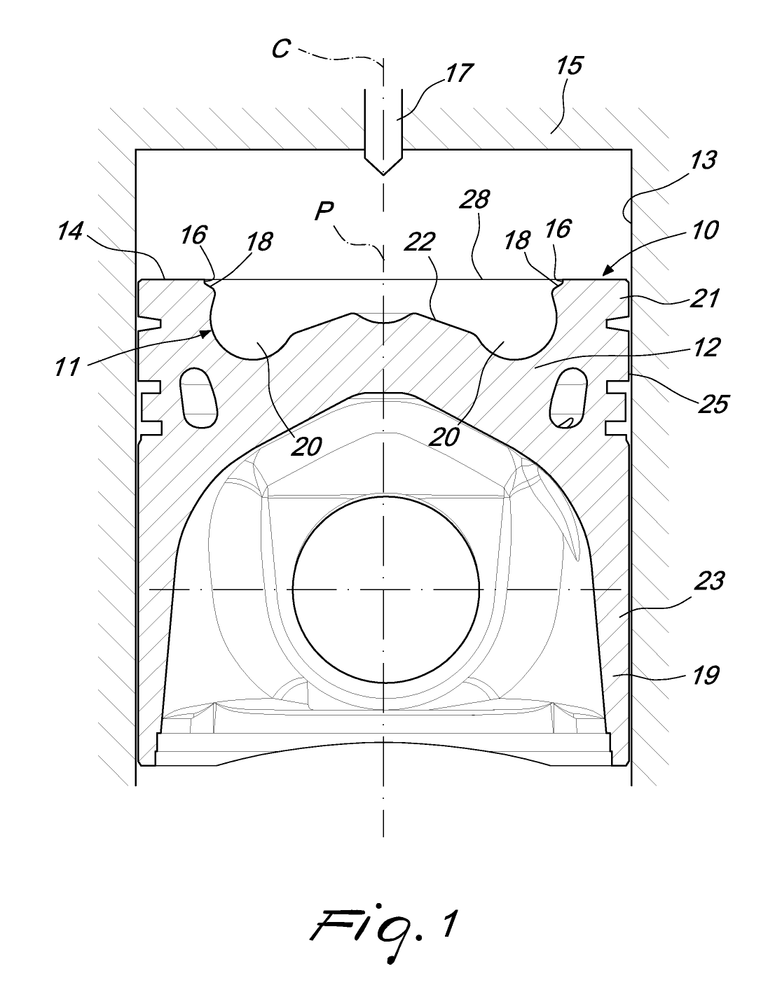

FIG. 1 illustrates a sectional view of a piston 10 for a diesel engine. The piston 10 may be slidably assembled into a cylinder 13 within a cylinder block 9 Piston 10 may have a central axis P. The cylinder 13 may have a cylinder head 15. The walls of the cylinder 13 may be provided with a cylinder liner (not shown). A fuel injector 17 may be positioned in the cylinder head 15. The fuel injector 17 may have a plurality of nozzles configured to inject fuel into the cylinder 13.

Cylinder 13 may have a longitudinal axis C. With the piston 10 assembled into the cylinder 13 the central axis P of the piston 10 may be aligned with the longitudinal axis C of the cylinder 13.

The fuel injector 17 may be configured to inject fuel at a spray angle (not shown). The spray angle may be defined as the angle between the piston central axis P and a nozzle in the fuel injector 17. The spray angle may determine the spray coverage within the piston 10.

Piston 10 may have a body 12. The body 12 may have a first end portion 21 and a second end portion 23. The body 12 may be delimited by an outer surface 25 extending from the first end portion 21 to the second end portion 23. Piston 10 may have a piston skirt 19 at the second end portion 23.

Body 12 may have a crown 14. Crown 14 may be substantially flat. Crown 14 may be disposed about a central axis P. Crown 14 may be symmetrical about the central axis P. Crown 14 may be disposed at the first end portion 21. Crown 14 may extend from the outer surface 25 towards the central axis P. Crown 14 may extend in a substantially transverse direction relative to the central axis P. Crown 14 may be perpendicular to the outer surface 25.

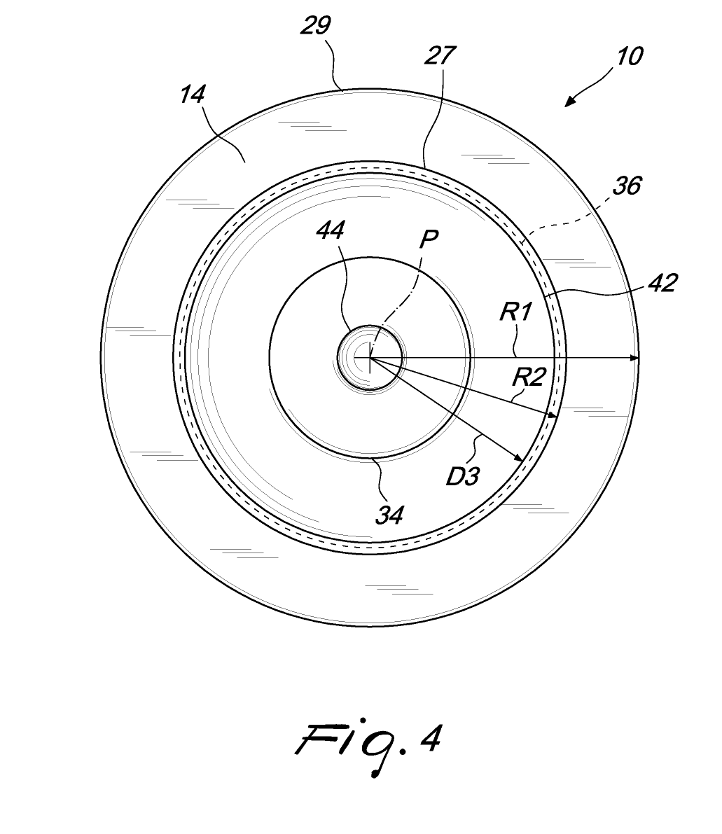

FIG. 4 illustrates a plan view of the piston 10. Crown 14 may be an annular ring having an inner radius R2 and an outer radius R1. The inner radius R2 may be measured from the central axis P to an inner edge 27 of the crown 14. The outer radius R1 of the crown 14 may be measured from an outer edge 29 to the central axis P. The outer edge 29 may be formed on the outer surface 25. Inner radius R2 may have a length of 37.25 mm.

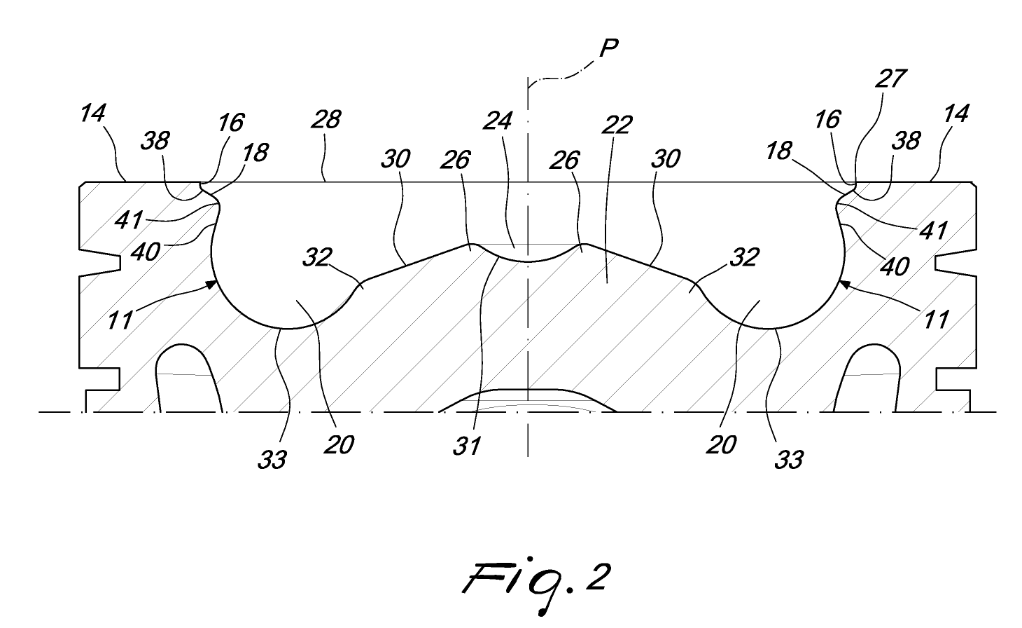

FIG. 2 illustrates a section of the combustion chamber 11. Piston 10 may have a combustion chamber 11. The combustion chamber 11 may be transversely disposed in the body 12. Combustion chamber 11 may be recessed into body 12 at the first end portion 21. Combustion chamber 11 may be recessed from the crown 14. Combustion chamber 11 may be symmetrical about the central axis P. Combustion chamber 11 may be disposed at the first end portion 21.

Combustion chamber 11 may have an opening 28 at the first end portion 21. Opening 28 may be delimited by the inner edge 27 of the crown 14. Opening 28 may have a radius equivalent to the inner radius R2 of the crown. Opening 28 may have a radius with a length of 37.25 mm. Opening 28 may be in alignment with the crown 14. Opening 28 may be level with the crown 14.

Within the cylinder 13, the piston 10 may be positioned so that the fuel injector 17 may inject fuel substantially into the combustion chamber 11. The fuel vapour injected into the combustion chamber 11 may be mixed with intake air which is then burnt in the combustion chamber 11. The combustion chamber 11 may be configured to receive injection of fuel vapour at a spray angle of approximately 67.5° to 70° relative to the central axis P.

With reference to FIG. 2, piston 10 may have a centre pip 22. Centre pip 22 may be disposed in the combustion chamber 11. Centre pip 22 may project from the combustion chamber 11 in a direction towards the opening 28. Centre pip 22 may be a convex projection. Centre pip 22 may form a central portion of the floor of the combustion chamber 11. Centre pip 22 may be disposed about the central axis P. Centre pip 22 may be symmetrical about the central axis P. Centre pip 22 may be annular. Centre pip 22 may be at least partially conical or domed.

Centre pip 22 may have a recess 24. Recess 24 may face opening 28. Recess 24 may be delimited by a recess floor 31. The recess floor 31 may be a partial spherical surface. Recess floor 31 may be a concave arc in cross section. Recess floor 31 may be a circular concave arc in cross section.

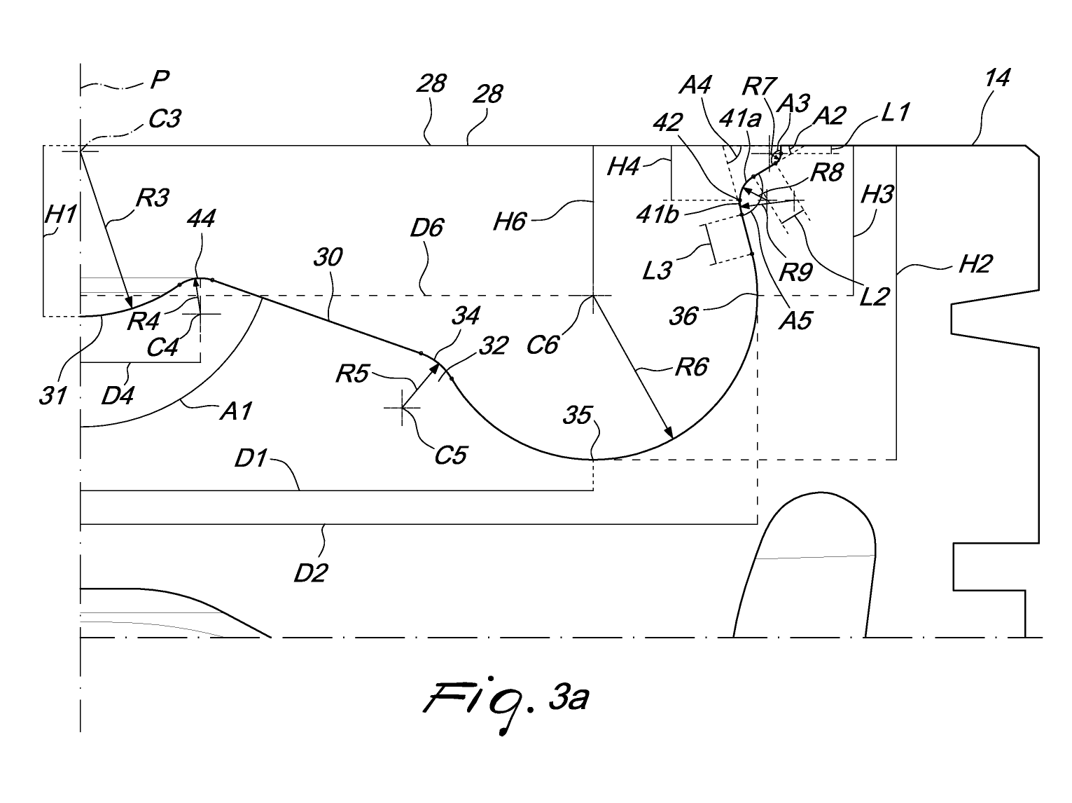

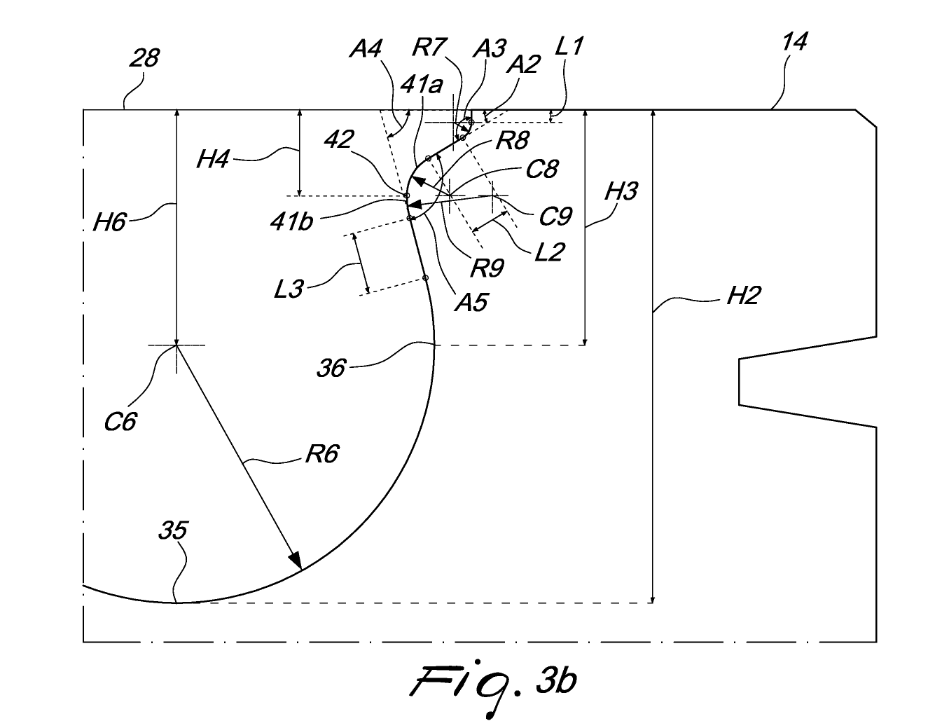

With reference to FIG. 3a, recess floor 31 may have a maximum recess depth H1. The maximum recess depth H1 may be coincident with the central axis P. The maximum recess depth H1 may be 9.38 mm from the opening 28. The recess floor 31 may have a radius R3 of 9.0 mm. The centre C3 from which radius R3 is measured may be coincident on the central axis P.

With reference to FIG. 2, centre pip 22 may have a recess transition 26. Recess transition 26 may be annular and concentric with the recess 24. Recess transition 26 may have a form of an annular ring. The annular recess transition 26 may represent the opening for the recess 24. Recess transition 26 may face the opening 28. Recess transition 26 may have a symmetrical axis that is substantially normal relative to the opening 28. Recess transition 26 may have a symmetrical axis that is substantially normal to the crown 14. The recess transition 26 may be symmetrical about the central axis P.

In cross section, the recess transition 26 may be formed as a remote pair of convex arcs. In cross section, the recess transition 26 may be formed as remote pair of circular convex arcs. The remote pair of circular convex arcs may be separated by the recess 24. Each circular convex arc may have a symmetrical axis that is substantially normal to the crown 14 and the opening 28.

With reference to FIGS. 3a and 4, recess transition 26 may have a recess transition apex 44. Recess transition apex 44 may be in the form of a continuous circular peak on the recess transition 26. The recess transition apex 44 may be the uppermost point on the centre pip 22 with respect to the opening 28. The distance from the recess transition apex 44 to the central axis P may be 6.75 mm.

With reference to FIG. 3a, in each section of the recess transition 26 the recess transition apex 44 may have an apex point. The distance between the centre pip 22 at the apex point and the opening 28 may be the smallest straight line distance from the centre pip 22 to the opening 28.

The recess transition 26 may have a radius R4 of 3.0 mm. Radius R4 may be measured from a centre C4. The distance D4 from the central axis P to the centre C4 may be 6.75 mm. The distance D4 from the central axis P to the centre C4 of a section of the recess transition portion 26 in the form of a circular convex arc may be 6.75 mm.

With reference to FIG. 2, centre pip 22 may have a floor portion 30. Recess transition 26 may connect the recess 24 to the floor portion 30. Floor portion 30 may be annular and concentric with the recess 24 and the recess transition 26. The floor portion 30 may extend from the recess transition 26 away from the central axis P. The floor portion 30 may extend radially from the recess transition 26. The floor portion 30 may be symmetrical about the central axis P.

With reference to FIG. 3a, floor portion 30 may be inclined relative to the crown 14 and the opening 28. Floor portion 30 may be inclined away from the crown 14 and the opening 28. Floor portion 30 may be inclined relative to the central axis P. Floor portion 30 may be inclined towards the central axis P. Floor portion 30 may be inclined relative to the central axis P at a floor angle A1 of 70°. The angle between the floor portion 30 and the crown 14 may be 20°.

The floor portion 30 may have sloped sides. In cross section, floor portion 30 may have sloped straight sides. The remote pair of sloped straight sides may be separated by the recess 24 and the recess transition 26.

With reference to FIG. 2, centre pip 22 may have a floor transition 32. Floor transition 32 may be annular and concentric with floor portion 30.

In cross section, the floor transition 32 may be formed as a remote pair of convex arcs. In cross section, the floor transition 32 may be formed as remote pair of circular convex arcs. Each circular convex arc may have a symmetrical axis that is substantially inclined to the opening 28 and the crown 14. The remote pair of circular convex arcs may be separated by the recess 24, the recess transition 26 and the floor portion 30. The floor transition 32 may be symmetrical about the central axis P.

With reference to FIGS. 3a and 4, floor transition 32 may have a floor transition apex 34. Floor transition apex 34 may be continuous circular peak. The floor transition apex 34 may be the lowermost point on the centre pip 22 with respect to the opening 28. In each section the floor transition apex 34 may have an apex point. The distance between the centre pip 22 at the apex point and the opening 28 may be the greatest straight line distance from the centre pip 22 to the opening 28.

With reference to FIG. 3a, the floor transition 32 may have a radius R5 of 3.0 mm. Radius R5 may be measured from a centre C5.

With reference to FIG. 1, piston 10 may have a bowl 20. The bowl 20 may be disposed in the combustion chamber 11. Bowl 20 may be formed as a groove projecting into the combustion chamber 11 in a direction substantially away from the opening 28. Bowl 20 may form a portion of the floor of the combustion chamber 11. Bowl 20 may be symmetrical about the central axis P.

With reference to FIG. 2, bowl 20 may be formed as a circular groove. Bowl 20 may be annular and may be concentric with the centre pip 22. Bowl 20 may be disposed about the centre pip 22. Bowl 20 may be connected to the centre pip 22 through the floor transition 32. Bowl 20 may be formed as a partial torus around the centre pip 22. Bowl 20 may extend radially out from the centre pip 22.

Bowl 20 may be delimited by a bowl surface 33. Bowl surface 33 may form part of the floor of the combustion chamber 11 with the floor portion 30 and the recess floor 31. Bowl surface 33 may extend towards the opening 28 and the crown 14 so as partially to form the sidewall of the combustion chamber 11.

With reference to FIGS. 3a and 3b, the bowl surface 33 may be a partial toroid surface. Bowl surface 33 may be a concave arc in cross section. Bowl surface 33 may be formed as a remote pair of circular concave arcs in cross section. The remote pair of circular concave arcs may be separated by the centre pip 22.

The bowl 20 may have a radius R6 of 9.0 mm. Radius R6 may be measured from a centre C6. The distance D6 from the central axis P to the centre C5 may be 26.9 mm. The distance D6 from the central axis P to the centre C6 of a section of the bowl 20 in the form of a circular concave arc may be 26.9 mm. The centre C6 may have a depth H6. The depth H6 may be 7.85 mm from the opening 28.

Bowl 20 may have a bowl bottom 35. Bowl bottom 35 may be formed as a continuous circular line on the bowl 20. The bowl bottom 35 may be the lowermost point on the bowl 20 with respect to the opening 28 and the crown 14. Bowl bottom 35 may have a maximum bowl depth H2 of 16.85 mm from the crown 14. The distance D1 from the central axis P to the bowl bottom 35 may be 26.9 mm.

Bowl 20 may have a bowl lateral limit 36. Bowl lateral limit 36 may be formed as a continuous circular line on the bowl 20. The bowl lateral limit 36 may be the furthermost lateral point on the bowl 20 with respect to the central axis P. The distance D2 from the central axis P to the bowl lateral limit 36 may be 35.9 mm. Bowl lateral limit 36 may have a depth H3 of 7.85 mm from the crown 14.

With reference to FIG. 1, piston 10 may have a lip 18. The lip 18 may be disposed in the combustion chamber 11. Lip 18 may form a portion of the sidewall of the combustion chamber 11. Lip 18 may be formed as an annular projection. Lip 18 may project into the combustion chamber 11. Lip 18 may extend radially into the combustion chamber 11. Lip 18 may be symmetrical about the central axis P.

With reference to FIG. 2, the lip 18 may have sloped sides. The lip 18 may have sloped straight sides. The sloped sides may be spaced apart, in cross section of the lip 18. A first sloped straight side may face the second sloped straight side.

With reference to FIGS. 3a and 3b, lip 18 may be inclined relative to the opening 28 and the crown 14. Lip 18 may be symmetrical about the central axis P. Bowl 20 may extend from the centre pip 22 to the lip 18 inclined relative to the crown 14. Lip may be inclined relative to the crown 14 at an angle A2 of 34°. The lip 18 may have a length L2 of 1.6 mm.

With reference to FIG. 1, piston 10 may have a wall 16. Wall 16 may be connected between the lip 18 and the crown 14. Wall 16 may limit angular distribution of fuel vapour and combustion products exiting the combustion chamber 11. Wall 16 may be annular. Wall 16 may be concentric with lip 18 and the crown 14. Wall 16 may form a portion of the sidewall of the combustion chamber 11. The uppermost portion of the combustion chamber 11 may be defined by the annular wall 16. Wall 16 may be parallel to the outer surface 25 of the piston 10. The wall 16 may have a radius of 37.25 mm.

With reference to FIG. 2, in cross section the wall 16 may be formed as remote straight sides. The straight sides may be mutually parallel.

With reference to FIGS. 3a and 3b, wall 16 may extend from the crown 14 and the opening 28 into the chamber 11 to connect with lip 18. Wall 16 may be substantially perpendicular to the crown 14. Wall 16 may be substantially perpendicular to the opening 28. Wall 16 may have a length L1 of 0.5 mm. Lip 18 may be inclined relative to the wall 16 at an angle A3 of 120°.

In an embodiment, with reference to FIG. 2, piston 10 may have a wall transition 38. Wall transition 38 may connect wall 16 to the lip 18. Wall transition 38 may be annular and concentric with wall 16 and the lip 18.

With reference to FIGS. 3a and 3b, in cross section, the wall transition 38 may be formed as a remote pair of concave arcs. In cross section, the wall transition 38 may be formed as remote pair of circular concave arcs. Each circular concave arc may have a symmetrical axis that is substantially inclined to the opening 28 and the crown 14. The wall transition 38 may be symmetrical about the central axis P. The wall transition 38 may have a radius R7 of 0.50 mm.

In an embodiment, with reference to FIG. 2, piston 10 may have a re-entrant portion 40. Re-entrant portion 40 may be connected between the lip 18 and the bowl 20. Re-entrant portion 40 may be annular. Re-entrant portion 40 may be concentric with lip 18. Re-entrant portion 40 may form a portion of the sidewall of the combustion chamber 11.

Re-entrant portion 40 may extend from the bowl 20 towards the opening 28. Re-entrant portion 40 may project into the combustion chamber 11. Re-entrant portion 40 may extend over a portion of the bowl 20. Re-entrant portion 40 may face the bowl 20. In cross section the re-entrant portion 40 may be formed as remote straight sides. The straight sides may be mutually inclined.

With reference to FIGS. 3a and 3b, re-entrant portion 40 may be substantially inclined relative to the crown 14. Re-entrant portion 40 may be inclined relative to the opening 28. Re-entrant portion 40 may be inclined relative to the opening 28 or the crown 14 at a re-entrant angle A4 of 75°. The re-entrant portion 40 may have a length L3 of 1.74 mm.

In an embodiment, with reference to FIG. 2, piston 10 may have a re-entrant transition 41. Re-entrant transition 41 may connect re-entrant portion 40 to the lip 18. Re-entrant transition 41 may be annular and concentric with the lip 18.

In cross section, the re-entrant transition 41 may be formed as a remote pair of convex arcs. In cross section, the re-entrant transition 41 may be formed as remote pair of circular convex arcs. Each circular convex arc may have a symmetrical axis that is substantially inclined to the opening 28 and the crown 14. The re-entrant transition 41 may be symmetrical about the central axis P.

With reference to FIGS. 3a and 3b, the re-entrant transition 41 may be comprised of a pair of circular arcs. The circular arcs may have different curvatures. The first arc 41a may extend from the lip 18 to a tangent point at which the re-entrant transition 41 may touch a line parallel with the central axis P. The first arc 41a of the re-entrant transition 41 may have a radius R8 of 1.5 mm. Radius R8 may be measured from a centre C8. The distance from the central axis P to the centre C8 may be 36.54 mm. The second arc 41b may extend from the tangent point to the re-entrant portion 40. The second arc 41b of the re-entrant transition 41 may have a radius R9 of 3.0 mm. Radius R9 may be measured from a centre C9. The distance from the central axis P to the centre C9 may be 38.04 mm.

With reference to FIG. 4, re-entrant transition 41 may have a re-entrant transition apex 42. Re-entrant transition apex 42 may be continuous circular peak extending around the combustion chamber 11. The distance from the central axis P to the re-entrant transition apex 42 may be smaller than the distance from the central axis P to the lip 18. The distance from the central axis P to the re-entrant transition apex 42 may be smaller than the distance from the central axis P to the re-entrant portion 40. The distance D3 from the central axis P to the re-entrant transition apex 42 may be 35.05 mm. In an embodiment, the re-entrant transition apex 42 may be at the tangent point at which the re-entrant transition 41 touches a line parallel with the central axis P.

With reference to FIGS. 3a and 3b, in each section the re-entrant transition apex 42 may have an apex point. The re-entrant transition apex 42 may have a depth H4 of 3.06 mm from the opening 28 or the crown 14. The re-entrant transition 41 may have a curvature angle A5 of 105°. The curvature angle may be formed between the lip 18 and the re-entrant portion 40.

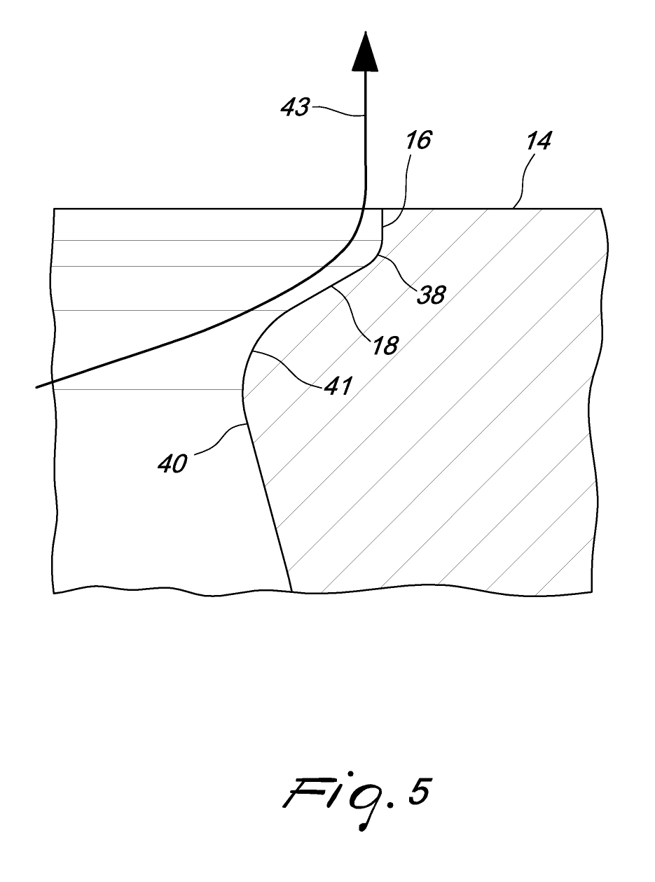

FIG. 5 illustrates a portion of the sidewall of the combustion chamber 11. Arrow 43 indicates the path of the fuel vapour and combustion products approaching the lip 18 and the wall 16. Fuel vapour injected into the combustion chamber 11 may rebound from the bowl 20 and exit from the combustion chamber 11. Fuel vapour and combustion products may rebound from the bowl surface 33. Fuel vapour and combustion products may impact the wall 16 and the rebound path may be diverted vertically upwards towards the cylinder head 15. Rebounding fuel vapour and combustion products may be diverted away from the wall of the cylinder 13. The angular distribution of the rebounding fuel vapour and combustion products may be limited by the wall 16.

The skilled person would appreciate that foregoing embodiments may be modified or combined to obtain the piston 10 of the present disclosure.

### INDUSTRIAL APPLICABILITY

This disclosure describes a piston 10 for a diesel engine. The diesel engine may be a direct-injection engine. The diesel engine may be a 4 cylinder engine. The piston 10 may reduce particulate matter emission in exhaust gases by decreasing the production of particulate matter during combustion of the fuel vapour in the combustion chamber 11. The piston 10 may have a reduced angular distribution of the fuel vapour and combustion products exiting the combustion chamber 11. The wall 16 may limit the spread of the fuel vapour out of the combustion chamber 11 onto the walls of the cylinder 13.

The piston 10 may have a structure that obstructs fuel vapour and combustion products that exits the combustion chamber 11 from reaching the walls of cylinder 13. The

The fuel vapour may be injected with a cone spray angle of approximately 135° to 140°. The fuel vapour may be injected with a cone spray angle of approximately 67.5° to 70° relative to the central axis P. The fuel may be injected in a direction substantially towards the bowl 20.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

Where technical features mentioned in any claim are followed by reference signs, the reference signs have been included for the sole purpose of increasing the intelligibility of the claims and accordingly, neither the reference signs nor their absence have any limiting effect on the technical features as described above or on the scope of any claim elements.

One skilled in the art will realise the disclosure may be embodied in other specific forms without departing from the disclosure or essential characteristics thereof. The foregoing embodiments are therefore to be considered in all respects illustrative rather than limiting of the disclosure described herein. Scope of the invention is thus indicated by the appended claims, rather than the foregoing description, and all changes that come within the meaning and range of equivalence of the claims are therefore intended to be embraced therein.

The disclosures in European Patent Application No. 13150525.7 from which this application claims priority are incorporated herein by reference.

1. A piston for a diesel engine, the piston comprising:
a body having a crown about a central axis;
a combustion chamber transversely disposed in the body and recessed from the crown;
a centre pip disposed in the combustion chamber about the central axis;
a lip inclined relative to the crown at an angle;
a bowl extending from the centre pip to the lip; and
a wall connected between the lip and the crown for limiting angular distribution of fuel vapour exiting the combustion chamber.

2. The piston of claim 1 wherein the angle is 34°.

3. The piston of claim 1 wherein the wall has a length of 0.5 mm.

4. The piston of claim 1 wherein the crown has an inner edge, the inner edge defines an opening having a radius of 37.25 mm.

5. The piston of claim 1 wherein the wall is perpendicular to the crown.

6. The piston of claim 1 further comprising a re-entrant portion connecting the lip and the bowl, wherein the re-entrant portion is inclined relative to the crown at a re-entrant angle.

7. The piston of claim 6 wherein the re-entrant angle is 75°.

8. The piston of claim 6 further comprising a re-entrant transition connecting the re-entrant portion to the lip.

9. The piston of claim 8 wherein the re-entrant transition has a first arc with a radius of 1.5 mm and a second arc with a radius of 3.0 mm.

10. The piston of claim 8 wherein the re-entrant transition has a curvature angle of 105°.

11. The piston of claim 1 wherein the lip has a length of 1.6 mm.

12. The piston of claim 1 wherein the bowl has a radius of 9.0 mm.

13. The piston of claim 1 wherein the bowl has a maximum bowl depth of 16.85 mm.

14. The piston of claim 1 wherein a wall transition connects the wall to the lip, the wall transition having a radius of 0.5 mm.

15. The piston of claim 1 wherein the combustion chamber is configured to receive injection of fuel vapour at a spray angle of approximately 67.5° to 70° relative to the central axis.

16. The piston of claim 2 wherein the wall has a length of 0.5 mm.

17. The piston of claim 2 wherein the crown has an inner edge, the inner edge defines an opening having a radius of 37.25 mm.

18. The piston of claim 2 wherein the wall is perpendicular to the crown.

19. The piston of claim 2 further comprising a re-entrant portion connecting the lip and the bowl, wherein the re-entrant portion is inclined relative to the crown at a re-entrant angle.

20. The piston of claim 7 further comprising a re-entrant transition connecting the re-entrant portion to the lip.
